(19) United States
(12) Patent Application Publication
(10) Pub. No.: US 2001/0016824 A1
(43) Pub. Date: Aug. 23, 2001

(54) Small sized information device, system and method for management of lending of small sized information devices, and computer product

(75) Inventor: Hiroyuki Matsushima, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: RICOH COMPANY, LIMITED, Tokyo (JP)

(21) Appl. No.: 09/753,582

(22) Filed: Jan. 4, 2001

(30) Foreign Application Priority Data
Jan. 6, 2000 (JP) 2000-001134

(51) Int. Cl. G06F 17/60

(52) U.S. Cl. 705/5

(57) ABSTRACT

The lending reservation system comprises client terminals and a digital camera server terminal connected to LAN. A digital camera can be connected to or disconnected from the server terminal. A user inputs information required to reserve the digital camera into any one of the client terminals. The client terminal transmits this information to the server terminal through LAN. The server terminal decides whether a reservation can be made. If the reservation can be made, the server terminal registers the reservation and informs the client terminal that the reservation is made.

### FIELD OF THE INVENTION

The present invention relates to a technology of carrying out the operations related to lending of a small sized information device using a terminal connected to a network. The related to lending include reservation of the information device the user wishes to borrow to returning of the borrowed information device. The small sized information device includes a digital still camera, a digital video camera and the like.

### BACKGROUND OF THE INVENTION

In recent years, a digital camera has been rapidly promoted as an image inputting device along with the popularization of a personal computer and the Internet and so on. For example, the cases have been increased such that the digital camera is used in a company and an office for taking pictures of progress and results of a business or scenes of an event and a report of a business journey or the like by a digital camera and transmitting these photo data by a mail via a personal computer, an image outputting device or an internet to report them in real time. Thus, when a company purchases a digital camera and manages lending of the digital camera, a method such that general software is used or a user writes down a lending managing note or the like. Alternatively, most of digital cameras employ a detachable smart medium and a memory card with a limited storage capacity as a recording medium of a pictured image.

Following technical literature disclose related matter. Japanese Patent Application Laid-Open (JP-A) No. 9-319960 discloses a technology to solve a problem in case a user forgets and does not returns a portable information device he/she has borrowed. Japanese Patent Application Laid-Open (JP-A) No. 10-93750 is solves the problem of competitive utilization of a scanner, when a plurality of clients share one scanner, by making a reservation for the scanner. Japanese Patent Application Laid-Open (JP-A) No. 10-164419 relates to a system in which photographing conditions of a camera can be controlled through a network. In JP-A No. 10-164419 when there occurs a double reservation, the fact is informed to the users.

However, since a registration operation for lending is complicated on managing lending of a digital camera as described above, there is often the case that the digital camera is lent by a verbal promise. This involves a problem such that it is not possible to know who posses the digital camera now. Alternatively, if the lending management is carried out severely, this involved a problem such that operation, which is required for lending the digital camera, is increased on each occasion and burden on an administrator is also increased.

Alternatively, depending on a standpoint of a user, it is necessary to install driver software or the like in a personal terminal on using a photographed image by a personal computer, so that there is a problem such that the photographed image is not capable of being easily utilized. Additionally, if the images are stored in a detachable medium, burden for managing is further increased. Further, when the stored mediums are distributed individually, the medium is very expensive, so that it involves a problem such that the medium is not economical.

According to Japanese Patent Application Laid-Open (JP-A) No. 9-319960, although the lent medium is prevented from being returned, reservation of lending and managing thereof are not carried out. Therefore, competition in reservation of lending occurs. According to Japanese Patent Application Laid-Open (JP-A) No. 10-93750 and Japanese Patent Application Laid-Open (JP-A) No. 10-164419, an image inputting device, which is used with being always connected, such as a scanner via a network or a device to be used with being connected are booked, so that they are not used with the connection from the system released.

### SUMMARY OF THE INVENTION

It is one object of this invention to share efficiently a small size information device and decrease the operation for managing lending of the small size information device.

It is an another object of the present invention to enable distribution of images without installing a dedicated drive software in a terminal and using a conventional medium by taking images from the small size information device from a server and transmitting the images to the terminal in accordance with a transmission method on reservation.

According to one aspect of the present invention, for example, on using the digital camera, a user of the digital camera performs the input operation for reservation from a client terminal, which is connected to a network, to a server terminal and the server terminal registers reservation of the digital camera and lend it depending on reservation input information from the client terminal, so that the reservation, the lending and management thereof are systemized and the lending reservation becomes capable of being inputted on the client terminal.

According to another aspect of the present invention, for example, on using the digital camera, a dedicated client software is not used but a WWW server is installed on the server terminal to build a system on a WWW. Then, the client terminal activates a general WWW browser and the user inputs a URL of the server terminal, so that a lending reservation page of the small size information device is displayed and the input operation is capable of being performed on this lending reservation page.

Other objects and features of this invention will become apparent from the following description with reference to the accompanying drawings.

### BRIEF DESCRIPTION OF THE DRAWINGS

FIG. 1 is a block diagram showing a constitution of a digital camera lending management system according to an embodiment of the present invention;

FIG. 2 is a block diagram showing an internal constitution of the digital camera in FIG. 1;

FIG. 3 is a block diagram showing an internal constitution of a digital camera server in FIG. 1;

FIG. 4 is an explanation drawing of an example of a main panel of a lending reservation client according to the embodiment of the present invention;

FIG. 5 is an explanation drawing of a user certification dialogue box of the lending reservation client according to the embodiment of the present invention;

FIG. 6 is an explanation drawing of a reservation success dialogue box of the lending reservation client according to the embodiment of the present invention;

FIG. 7 is an explanation drawing of a reservation failure dialogue box with respect to a failure of the certification on lending reservation according to the embodiment of the present invention;

FIG. 8 is an explanation drawing of a reservation failure dialogue box, in the case that the reservation desired date is already reserved, on lending reservation according to the embodiment of the present invention;

FIG. 9 is an explanation drawing showing a panel example for reservation inspection and reservation cancellation according to the embodiment of the present invention;

FIG. 10 is a flowchart showing a reservation processing example according to the embodiment of the present invention;

FIG. 11 is a flowchart showing a lending processing example according to the embodiment of the present invention; and

FIG. 12 is a flowchart showing a restoration processing example according to the embodiment of the present invention.

### DESCRIPTION OF THE PREFERRED EMBODIMENTS

Preferable embodiment of the present invention will be explained with reference to the accompanying drawings below. It is assumed here that the small sized information device is a digital camera. However, the present invention is not limited to this embodiment.

According to the present invention, upon using the digital camera, a user manages the operation from lending reservation to restoration via a terminal, which is connected to the network. The summary of the present invention is as follows. At first, a digital camera server terminal receives lending reservation, which is accessed from the terminal, and manages it. Then, when the user wishes to use the digital camera in actual, the digital camera server terminal checks the user's certification by the IC card and the password or the like and the reservation. It the check is successful, the digital camera server terminal transmits a setting signal, which is capable of being used by the digital camera, to the digital camera. After that, when the user returns the digital camera, the digital camera server terminal reads the image data and transmits the image data by a transmission method, which the user desires, in accordance with reservation. The constitution and the operation of the system will be explained below.

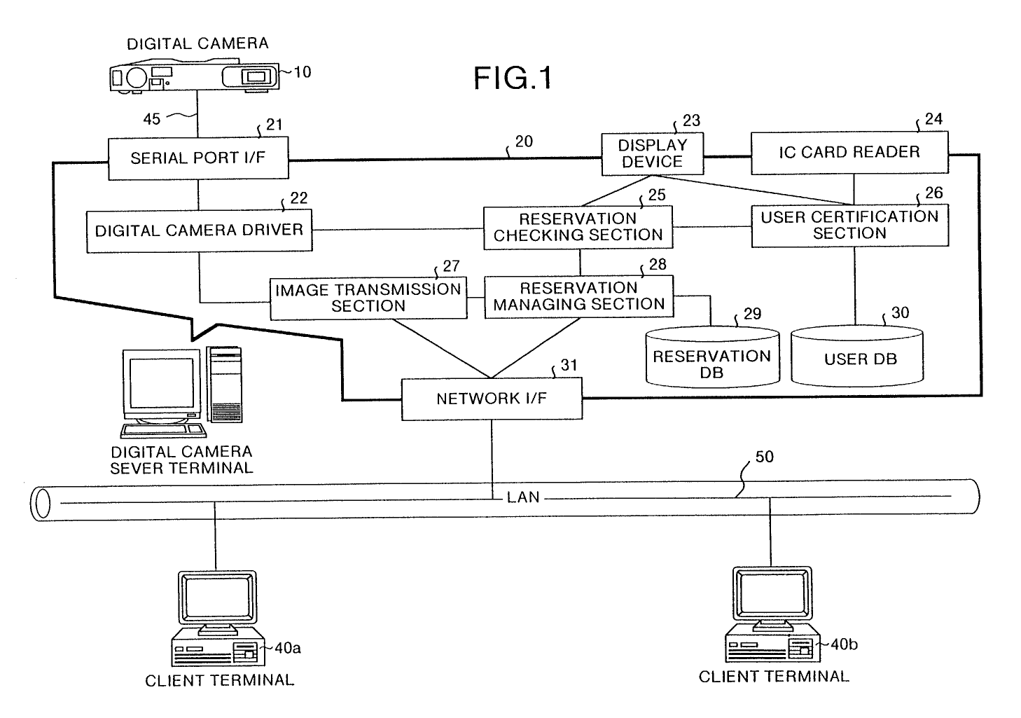

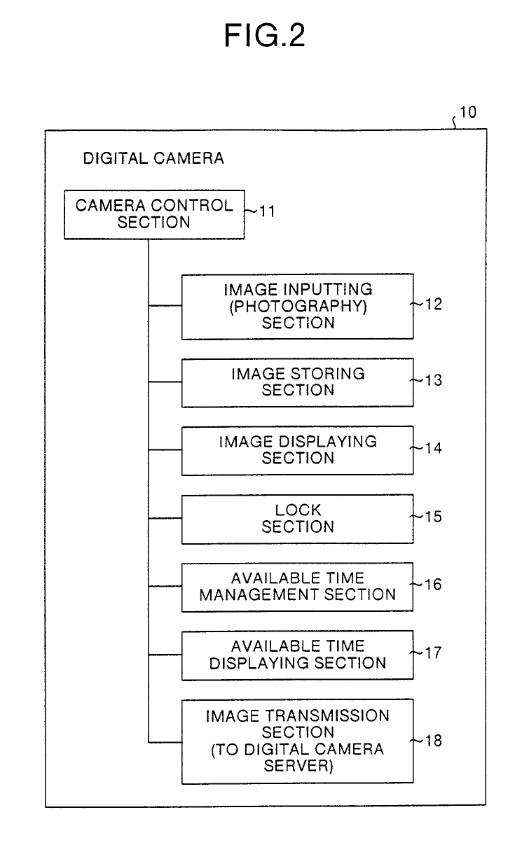

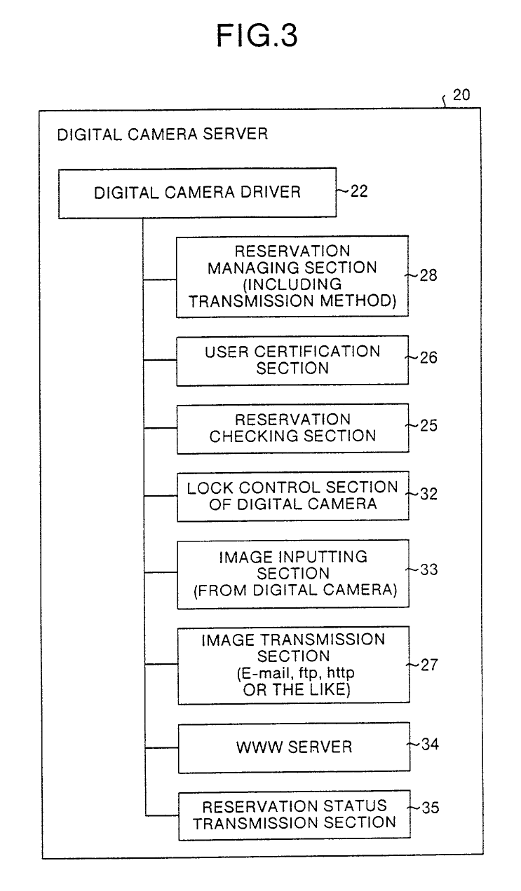

FIG. 1 is a block diagram showing a constitution of a digital camera lending management system according to an embodiment of the present invention. FIG. 2 is a block diagram showing an internal constitution of the digital camera in FIG. 1. FIG. 3 is a block diagram showing an internal constitution of a digital camera server in FIG. 1.

In this system, a digital camera 10 is connected on a LAN 50 by a cable 45 and a digital camera server 20 for managing lending reservation of the digital camera 10 and a client terminals 40a and 40b for reserving (accessing) lending of the digital camera 10 are connected on the LAN 50 in a broad sense. A printer is connected to the LAN 50 (not illustrated). FIG. 1 shows only one digital camera 10, however, a plurality of digital cameras maybe provided. When there are many digital cameras, all the cameras may of the same type or each digital camera may be of different type. Further, the digital camera 10 is shown to be connected to the digital camera server terminal 20 through the cable 45, however, the digital camera 10 may be made to communicate with the digital camera server terminal 20 using radio waves such as infrared rays.

The digital camera server terminal 20 comprises a serial port I/F 21, a digital camera driver 22, a display device 23, an IC card reader 24, a reservation checking section 25, a user certification section 26, an image transmission section 27, a reservation managing section 28, a reservation database (DB) 29, a user database (DB) 30 and a network I/F 31.

The serial port I/F 21, for example, uses a serial interface such as an RS-232C or USB (Universal Serial Bus) or the like. When reserving or after returning the digital camera, the I/F section of the digital camera 10 and the digital camera server terminal 20 are connected by the cable 45 to transmit a predetermined signal to the digital camera 10. The digital camera driver 22 controls a whole of the digital camera server terminal 20 collectively. The display device 23 displays information associated with lending reservation/restoration.

The IC card reader 24 is a device which reads the ID (identification number) of a user when the user inserts his/her IC card in it. The reservation checking section 25 has a function for checking the reservation status and displaying the status on the display device 23. The user certification section 26 authenticates the user ID (and a password and fingerprint or the like) which is inputted by the IC card reader 24, by searching the user information, which is stored in the user database 30.

The image transmission section 27 reads the image data from the digital camera 10 and transmits the images in accordance with setting. The reservation managing section 28 manages lending reservation and restoration and so on in accordance with information, which is transmitted from the client software via the network I/F 31, and information, which is stored in the reservation database (DB) 29.

Alternatively, as shown in FIG. 3, the digital camera server terminal 20 comprises a lock control section 32 for transmitting a lock/release signal of the digital camera 10 in accordance with success/failure of reservation checking, an image inputting section 33 for inputting the images from the digital camera 10 via the serial port I/F 21, a WWW (World Wide Web) server 34 for searching a Web page by a HTTP (Hyper Text Transfer Protocol) and a reservation status transmission section 35 for transmitting the reservation status. Alternatively, the WWW server 34 may be installed according to need.

The present embodiment will be explained taking a system in accordance with the IC card using the IC card reader 24 and its password as an example. However, in addition to the above system, a system in accordance with a well known magnetic card and a system in accordance with fingerprint checking may be used. In other words, in the case of the magnetic card, a magnetic card reader may be provided in place of the IC card reader 24 and in the case of the fingerprint, a fingerprint image inputting device may be provided in place of the IC card reader 24.

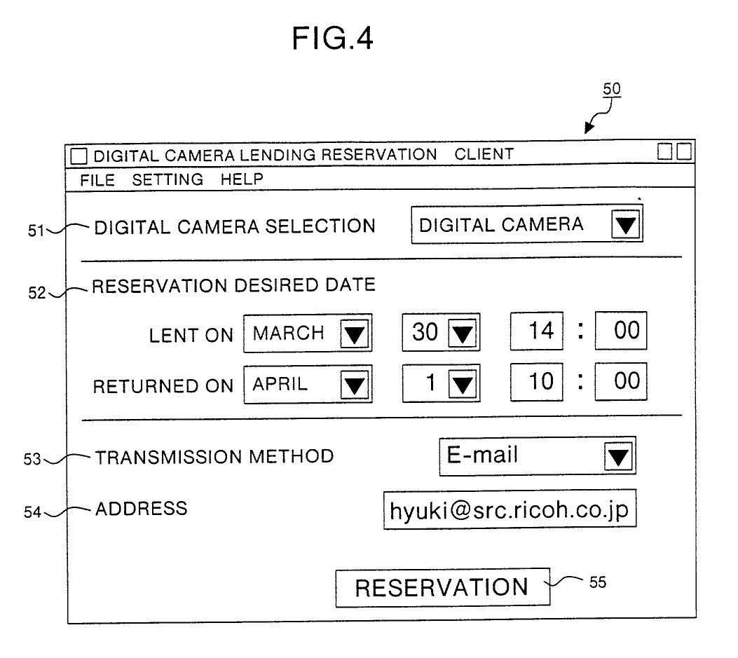

A GUI (graphical user interface) of the client software, which is described later in FIG. 4 to FIG. 9, is installed in the client terminals 40a and 40b.

As shown in FIG. 2, in the digital camera 10, an image inputting (photography or shooting) section 12 for inputting images by a lens and CCD or the like, an image storing section 13 for storing photographed images, an image displaying section 14 for displaying the case of monitoring the images, a lock section 15 for realizing the lock function such as photography possible/photography impossible by a signal from the outside, an available time management section 16 for managing the time, which is available by reservation lending and an available time displaying section 17 for displaying the time, which is available by reservation lending and an image transmission section 18 for transmitting the images to the digital camera server terminal 20 are connected to a camera control section 11 for controlling a full body of the camera.

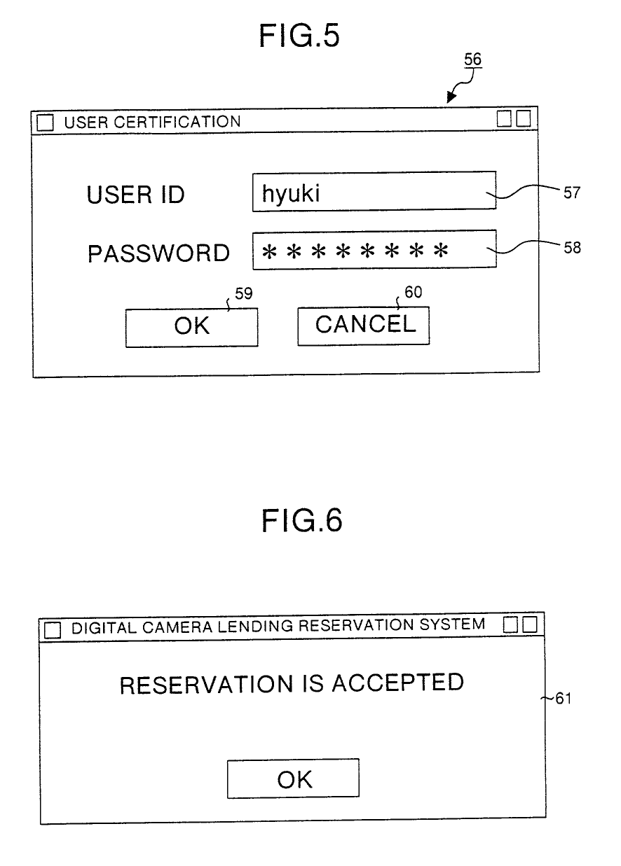

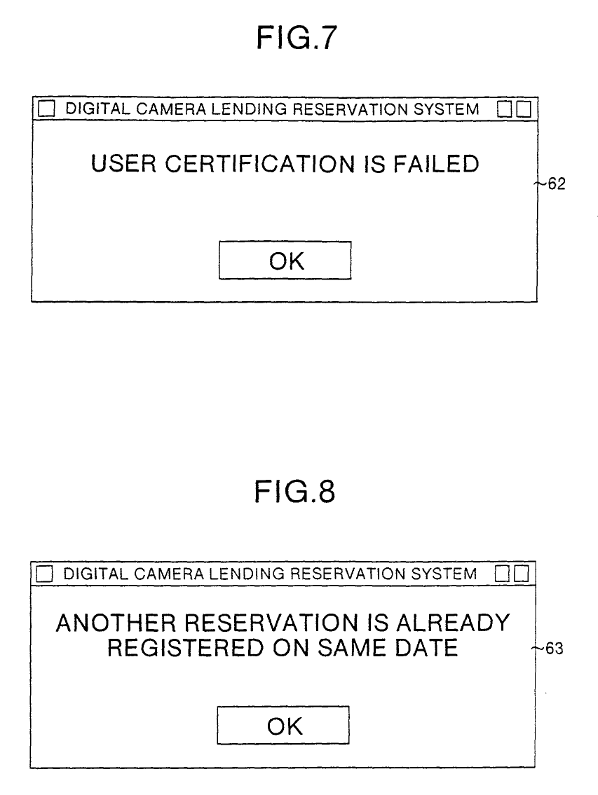

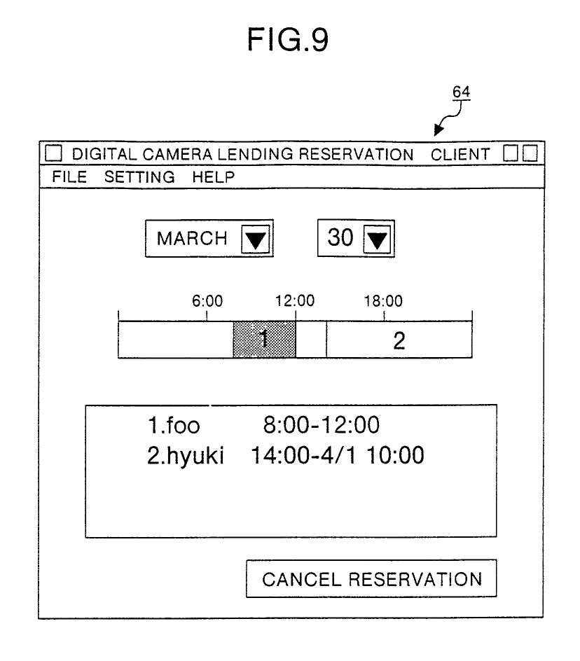

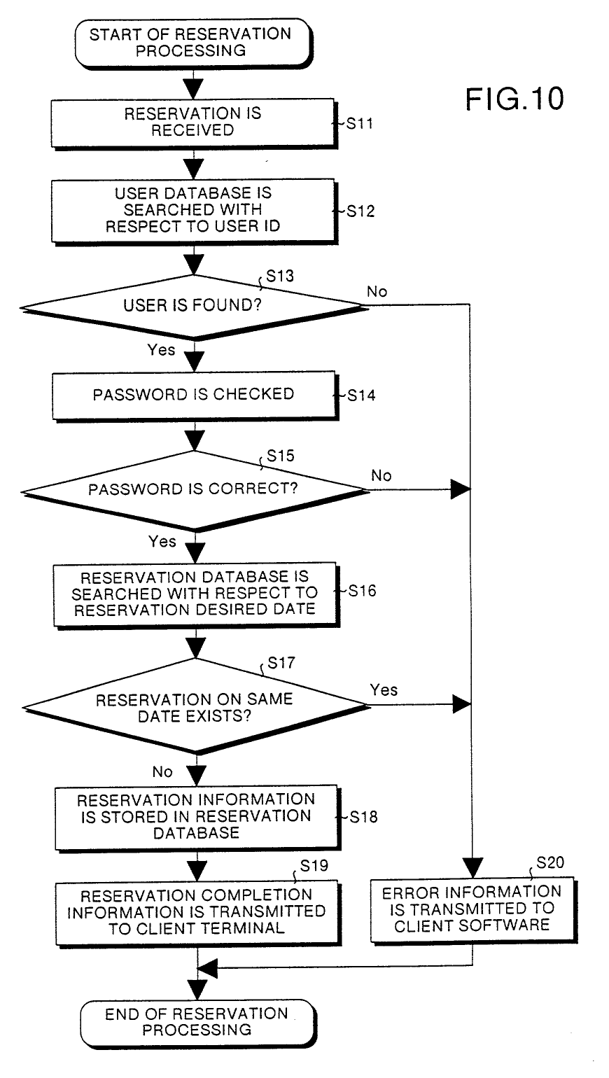

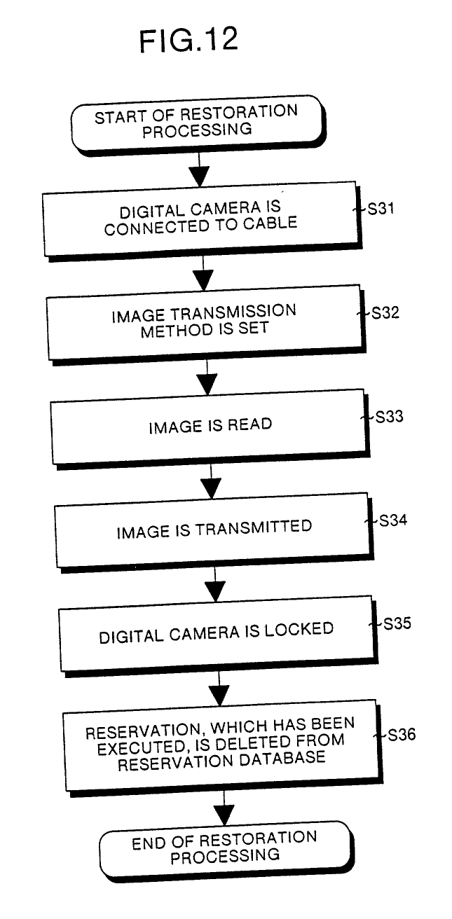

Operation of the digital camera lending management system and the digital camera will be explained with reference to explanation diagrams shown in FIG. 4 to FIG. 9 and flowcharts shown in FIG. 10 to FIG. 12 in the order of reservation, lending, restoration, confirmation of reservation status and cancellation of reservation. FIG. 4 illustrates a main dialogue box, FIG. 5, a user certification dialogue box, FIG. 6, a reservation success dialogue box, FIG. 7, a reservation failure dialogue box with respect to failure of certification, FIG. 8, a reservation failure dialogue box in the case that the reservation desired date is already reserved, and FIG. 9, a reservation inspection and cancellation panel, respectively. Additionally, a whole window is referred to as a dialogue box and an enflamed section is referred to a button. This button is clicked to be selected (inputted).

The reservation processing will be explained below. At first, operating any one of the client terminals 40a and 40b, a main dialogue box 50 is displayed. A digital camera selection 51 for selecting a digital camera name, a reservation desired date 52, a transmission method 53, an address 54 and a reservation button 55 are displayed on the main dialogue box 50. They are capable of being inputted.

In the main dialogue box 50 in FIG. 4, selecting the name of the digital camera, inputting the reservation desired date (lending date, restoration date), the transmission method and the address, the reservation button 55 is clicked. Then, a dialogue box 56 for the user certification is displayed (FIG. 5). Here, a user ID 57 and a password 58 are inputted. If the input is correct, an OK button 59 is clicked and if it is incorrect or it should be cancelled, a cancel button 60 is clicked. Alternatively, after inputting the user ID and the password, if the user wishes to continue the reservation, the OK button 59 is clicked and if the user does not wish to continue the reservation, the cancel button 60 is clicked.

Inputting the user ID and the password, the reservation desired date, the transmission method, the user ID and the password are transmitted from the client terminals 40a and 40b to the digital camera server 20 via the LAN 50. The digital camera server 20 receives the above described input information, respectively to display in accordance with reservation success/reservation failure. In other words, when the input information is correct and the reservation is not overlapped (competed), a reservation success dialogue box 61 indicating “reservation is accepted” is displayed as shown in FIG. 6.

On the other hand, when the inputted user ID and the password are found to be incorrect as a result of the certification, a reservation failure dialogue box 62 indicating “the user certification is failed” is displayed as shown in FIG. 7. Alternatively, when another reservation is already registered in the inputted reservation desired date, a reservation failure dialogue box 63 showing “another reservation is already registered in the inputted reservation desired date” is displayed as shown in FIG. 8.

FIG. 10 is a flowchart showing the operation of reservation processing. At first, in the digital camera server 20, the reservation managing section 28 receives the reservation information, which is transmitted from the client software via the network I/F 31 (step S11). In this case, if the reservation information is encrypted, it will be decrypted. Then, transmitting the user ID and the password to the user certification section 26, the user certification section 26 checks them with the user database 30 to authenticate them (step S12), so that it is judged whether the user is found or not (step S13), in other words, the user certification is carried out.

In the case that it is confirmed that the user ID exists in the user database 30 and it is judged that the user is found, the password is checked (step S14) After that, it is judged whether the inputted password is correct or not (step S15). In this case, if the password is judged to be correct, the reservation database 29 is searched with respect to a reservation desired date (step S16).

As a result of the above search, it is judged whether the reservation of the reservation desired date exists or not (step S17). In this case, if it is judged that the reservation desired date is not reserved in the reservation database 29, the reservation information is stored in the reservation database 29 (step S18) and reservation completion information is transmitted to the client terminal (step S19). Alternatively, in the case that the reservation is successful, the reservation success dialogue box shown in FIG. 6 is displayed.

On the other hand, in the case that it is judged that the user is not found in the above step S13, or the password is incorrect in the above step S15, or the reservation is overlapped in the above step S17, error information is transmitted to the client software (step S20). The client software displays the reservation failure dialogue box shown in FIG. 7. Alternatively, in the case that the reservation date is overlapped, the client software displays the reservation failure dialogue box shown in FIG. 8.

In the mean time, checking with a directory server, which is connected to the network when the user database 30 is not provided in the digital camera server 20, the user certification as same as the above may be carried out. Alternatively, if the client software has a function to store setting such as a transmission method or the like in a file or the like, a desired setting will be easily performed by reading the stored file.

Additionally, when the client software has a function to search the available digital camera server terminal 20 automatically, even in the case that the user of a mobile terminal such as a note PC or the like connects one's PC to the network away from home, searching the near digital camera server terminal 20 and setting the transmission method usually enable the digital camera to be reserved. Alternatively, in this case, it is assumed that the same kind of digital camera server 20 is also connected to the network away from home. Further, if the transmission of the reservation information to the digital camera server 20 needs more security, the reservation information may be encrypted.

Other than using the dedicated client software in the above described reservation processing, installing the WWW server 34 (see FIG. 3) in the digital camera server 20, a system may be built on the WWW. In this case, the client terminals 40a and 40b activate the general WWW client software (browser software) and the user inputs a URL (uniform resource locator) of the digital camera server 20 to access the digital camera server 20. As a result, the same page as that in FIG. 4 will be displayed.

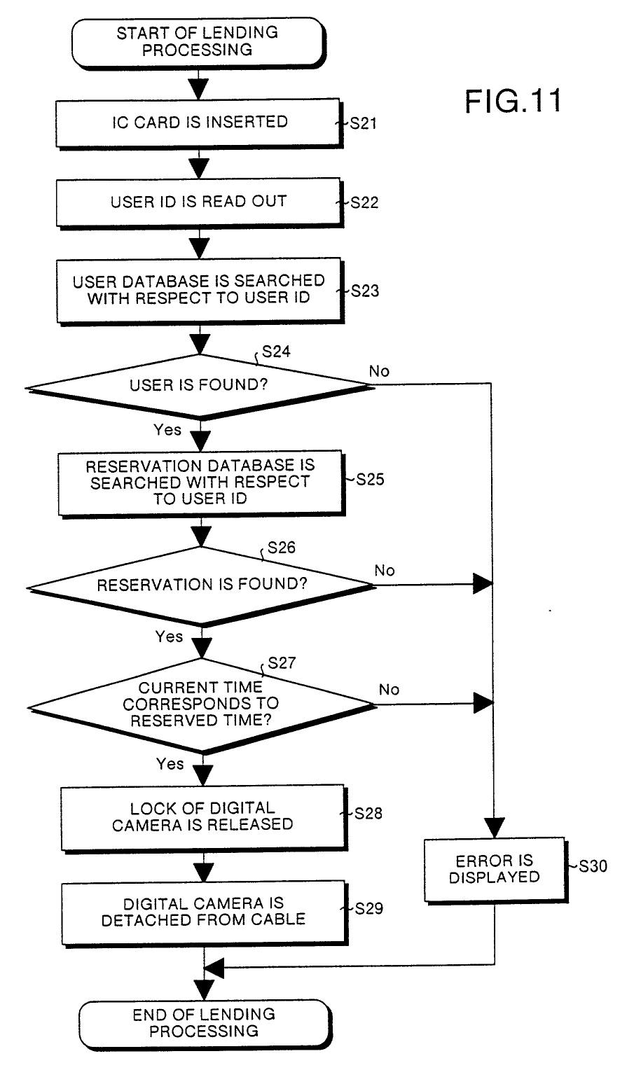

The operation performed when lending the digital camera 10 will now be explained. FIG. 11 is a flowchart illustrating the lending processing. At first, the user inserts the IC card, in which one's user ID is stored, into the IC card reader 24, which is housed in the digital camera server 20 (step S21). The user certification section 26 reads out the user ID through the IC card reader 24 (step S22) and the user certification section 26 checks (searches) the user database 30 with respect to the corresponding user ID (step S23).

As a result of searching in the above step S23, it is authenticated whether the user ID read in the user database 30 exists or not, in other words, it is judged whether the user is found or not (step S24). If the certification is failed, a message indicating the digital camera is not available is displayed on the display device 23 (step S30) On the other hand, in the case that it is judged that the user is found, the reservation managing section 28 searches the reservation database 29 with respect to the user ID (step S25) to return the result to the reservation checking section 25.

Consequently, the reservation checking section 25 judges whether the reservation is found or not from the result of the above step S25 (step S26). In this case, if it is judged that the reservation is not found, in other words, it is judged that the reservation in not registered, this is displayed on the display device 23 (step S30). On the other hand, if the reservation is registered, the reservation checking section 25 compares the current time with a reserved time to judge whether the current time corresponds to the reserved time or not (step S27). In this case, if the both of times do no correspond to each other, a message that the both of times do no correspond is displayed on the display device 23 (step S30).

When the two time parameters correspond to each other in the above step S27, the lock of the digital camera 10 is released (step S28). In other words, if the reservation checking is successful, the lock/release signal is transmitted to the digital camera 10. Alternatively, the lock/release signal includes the information of the reservation date. After that, the digital camera 10 is detached from the cable 45 (step S29).

Thus, lending of the digital camera 10 is successful and the user is capable of detaching the digital camera 10 from the cable 45 and using it. If the used time is over the reserved time, the user is not capable of using the digital camera 10 again. A display panel of the digital camera 10 is capable of displaying rest of the used time. If the used time is over, the display panel of the digital camera 10 displays a message for encouraging returning the digital camera 10. Hereinafter, is becomes impossible to take a picture and store the photograph even pushing a release button.

The operation performed when returning the borrowed digital camera 10 will now be explained below. At first, the user concludes using the digital camera 10 and connects the digital camera 10 to the cable 45 of the digital camera server 20 again (step S31) to return the digital camera 10. When the digital camera 10 is returned, the reservation managing section 28 takes in the image transmission method from the reservation in execution to set the image transmission method by the image transmission section 27 (step S32).

In accordance with the image transmission method, which is set, at first, the digital camera 10 takes in the image (step S33) to transmit the image, which is taken in (step S34). After that, locking the digital camera 10 (step S35), the reservation which has been executed is deleted from the reservation database 29 (step S36).

Alternatively, the followings may be used as the image transmission method. For example, the image may be transmitted by attaching it to an email. In this case, encoding the image and attaching it to the email, the encoded images are transmitted to the designated mail address. As a second method, the image may be transmitted through FTP (File Transfer Protocol) server, which enables the transference of files between different systems and the transference of different structural files, is used.

According to the method by the FTP server, the FTP connection is established with respect to the designated FTP server and the data is transmitted to the designated directory in accordance with the FTP. Alternatively, the FTP comprises a file transfer protocol, which is provided by a TCP/IP (Transmission Control Protocol/Internet Protocol). Making good use of the FTP, it is possible to store the image data in the FTP server without passing through a medium such as a floppy disk and with omitting the labor of the receiver.

As another method, a file is uploaded to the designated directory by using a PUT method (file transfer by a PUT command) of an HTTP (Hyper Text Transfer Protocol) with respect to the HTTP server. As a fourth method, the data may be transmitted to a printer. In this case, the data is transmitted to the designated printer in accordance with the protocol, which is supported by the printer and the data is printed out.

Alternatively, in place of installing the WWW server's function (WWW server 34) in the digital camera server 20 and transmitting the image data, a method for storing the data in the digital camera server terminal 20 may be used. In this case, using the WWW browser from the client terminals 40a and 40b and accessing the digital camera server terminal 20, the image data is capable of being inspected.

The operation performed when checking the reservation status and cancellation of the reservation will be explained below. Setting a function for confirming the reservation status and canceling the reservation, a more usable system is realized. FIG. 9 shows a panel example for reservation inspection and reservation cancellation. The client software displays a panel as shown in FIG. 9. If the user selects the data, the reservation status of the designated date is displayed by a graph and a list, which are indicated graphically along a time axis. Clicking (highlighting) the reservation, which is registered by the user oneself in the list and clicking the reservation cancellation button, the client software requires the reservation cancellation with respect to the digital camera server terminal.

Thus, according to the above described embodiment, on using the digital camera 10, it is not possible to take a picture by the digital camera 10 unless the digital camera 10 is reserved to release the lock function thereof. Alternatively, when the reserved time is over, the function of the digital camera 10 is not capable of being used again, SO that it is possible to prevent the digital camera 10 from being missing as it is not returned. Since the all reservation/lending operation is computerized, it is possible to decrease extremely the management operation of lending.

Although the user is required to perform the accessing operation for reservation, the labor for moving the photographed images to the user's PC and installing the device driver is decreased, so that the user is capable of using casually the digital camera. Therefore, according to this embodiment, it is possible to share the digital camera efficiently.

Additionally, a combination of the digital camera server terminal 20 (the lending reservation management server) and the digital camera 10 (a device provided with a lock function) according to the present embodiment is capable of being used efficiently in the lending management of devices other than the digital camera 10, for example, a portable terminal, a portable telephone, a game machine or a PC provided with a camera function and a mobile device or the like.

As explained above, with respect to a small sized information device lending management system according to one aspect of the present invention, for example, on using the digital camera, the user of the digital camera performs the reservation input operation with respect to the server terminal from the client terminal, which is connected on the network and the server terminal registers the reservation of the digital camera and lends it in accordance with the registration input information from the client terminal, so that the operation from reservation to lending and management thereof is systemized and it becomes possible to input for reservation of lending on the client terminal. Therefore, the digital camera is capable of being shared Efficiently via the network and the managing operation (work) from lending to restoration thereof is capable of being decreased.

According to the small sized information device lending management system according to another aspect of the present invention, for example, on using the digital camera, the dedicated client software is not used, the WWW server is installed on the server terminal to build a system on the WWW, the client terminal activates a general WWW browser and the user inputs the URL of the server terminal, so that a lending reservation page of the small sized information device is displayed and the input operation is capable of being performed in the lending reservation page. Therefore, the digital camera is capable of being lent, managed and shared efficiently by the terminal on the network and the managing operation (work) from lending to restoration is capable of being decreased.

Furthermore, in the case that the server terminal authenticates the user and the user certification is successful, checking the user with the reservation status to confirm the reservation registration, the digital camera is lent. Therefore, if the user who does not register the reservation yet tries to use the digital camera, it is not possible to borrow the digital camera by means of the user certification. As a result, accurate lending and managing thereof are realized.

Furthermore, in the case of authenticating the user, checking the inputted user ID and the password with the user information, which is already registered in the user base in advance, the user certification is capable of being performed reliably. Therefore, the case that the digital camera is lent to the user who does not register the reservation by mistake is avoided.

Furthermore, as the user certification, the magnetic card is used to check the user ID and the password, which are registered in the magnetic card with the user information, which is registered in the user base in advance, so that the user certification and lending are realized by the rather low-cost magnetic card.

Furthermore, as the user certification, the IC card is used to check the user ID and the password, which are registered in the IC card with the user information, which is registered in the user base in advance, so that the certification data becomes more reliable than the data in the magnetic card. Therefore, more reliable user certification and lending management are realized.

Furthermore, as the user certification, the fingerprint certification is used to check the user ID and the password, which are registered in the IC card with the user fingerprint, which is registered in the user base in advance, so that the IC card or the like is not needed and the user simply puts one's finger on the fingerprint image inputting section. Therefore, a simple and reliable lending management is realized.

Furthermore, for example, on lending the digital camera after registration of lending reservation thereof, the lock of the digital camera is released after the user certification is successful, so that when the user who does not registers the reservation tries to use the digital camera, the digital camera is locked and it becomes possible that the case the digital camera is used without permission is prevented.

Furthermore, for example, on reserving the digital camera, a method for transmitting the images are designated and the server terminal transmits the images via the network in accordance with the transmission method, which is designated at reservation on returning the digital camera, so that the images are transmitted not via a medium but via the network when the images are distributed to individuals by using a storage medium such as a conventional smart medium or the like. Therefore, the digital camera is capable of being managed rather simply and the cost of the medium is not needed, so that such a small sized information device lending management system is economical.

Furthermore, for example, in the case of transmitting the images, which is taken into the server terminal from the digital camera, to the client terminal, the electronic computer originated mail is used, so that it is possible to receive the images with a simple operation such as a normal mail reception without using the storage medium such as a smart medium or the like in order to distribute the images to the designated address.

Furthermore, for example, in the case of transmitting the images, which is taken into the server terminal from the digital camera, to the client terminal, a FTP (file transfer protocol) to be provided by the TCP/IP is used, so that the image transfer is reliably performed not through a medium such as a floppy disk or the like and even when the receiver does not always attends there.

Furthermore, for example, in the case of transmitting the images, which is taken into the server terminal from the digital camera, to the client terminal, a PUT command (file transfer) of the HTTP is used to transfer the images to the receiver, so that the image transfer is reliably performed not through a medium such as a floppy disk or the like and even when the receiver does not always attends there.

Furthermore, for example, the images, which are taken into the server terminal from the digital camera, is outputted to a printing device such as a printer, so that forming the images on a recording paper, which is outputted by the printing device, realizes the image distribution not through a medium such as a floppy disk or the like.

Furthermore, for example, the images, which are taken into the server terminal from the digital camera, is not transmitted to the client terminal but is stored in the WWW server. Then, it is possible that the client terminal accesses the server terminal using the WWW browser and the images are taken out. Therefore, the user is capable of inspecting the images according to need.

According to the small sized information device of still another aspect of the present invention, for example, since the digital camera is provided with a lock mechanism, by which the digital camera is locked ON/OFF with an external signal, even when the user who does not register the reservation tries to use the digital camera without permission, it is possible to prevent the digital camera from being missing.

Furthermore, the system displays the rest of the reserved time on the displaying device and the camera (device) is locked when the reserved time is over. As a result, priority is given to the use in accordance with the reservation registration and chances such that the reservation use is completed become high.

According to the lending reservation method of still another aspect of the present invention, for example, using a series of operation (work) such as the reservation registration for lending the digital camera, the reservation confirmation on lending of the digital camera and locking on/off of the digital camera as a software, it is possible that the digital camera is shared efficiently via the network and the management operation (work) from lending to restoration of the digital camera is capable of being decreased.

Furthermore, the images are transmitted from the digital camera via the network in accordance with the designated image transmission method, so that it becomes possible that the images are transmitted to a predetermined receiver's terminal not via a medium but via the network when the images are distributed to individuals by using a storage medium such as a conventional smart medium or the like. Therefore, the digital camera is capable of being managed rather simply and the cost of the medium is not needed, so that such a small sized information device lending management system is economical.

Furthermore, the user is capable of selecting and designating any one of the electronic computer originated mail, the FTP (file transfer protocol) in the TCP/IP, the PUT command (file transfer) of the HTTP, a printer output and a method for storing in the WWW server in accordance with an appropriate method. Therefore, the image distribution is realized by an appropriate method and without the storage medium.

The present document incorporates by reference the entire contents of Japanese priority document, 2000-001134 filed in Japan on Jan. 6, 2000.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A small sized information device lending management system comprising:
a client terminal connected to a network; and
a server terminal also connected to said network and to which a small sized information device can be connected using a cable or radio waves;
wherein said client terminal transmits information related to reservation for lending said small sized information device, which information is inputted by a user, to said server terminal via said network;
said server terminal receives the information related to reservation from said client terminal, judges whether reservation for lending said small sized information device can be registered or not in accordance with the received information, and if it is judged that the reservation can be registered, registers the reservation and transmits an information to said client terminal which indicates that the reservation has been registered.

2. The lending management system according to claim 1, wherein said server terminal comprises a user certification unit which authenticates a user in accordance with input information of the user and a lending permission unit which checks the user input information, which is provided with an access right by said user certification unit, and said reservation registration information; in the case that they correspond with each other, permitting to lend said small sized information device.

3. The lending management system according to claim 2, wherein said user certification unit carries out the user certification by checking a user ID to be inputted and a password with the user information, which is provided in advance.

4. The lending management system according to claim 2, wherein said user certification unit is provided with a magnetic card reader for reading the magnetic card, in which the user ID is registered, and carries out the user certification by checking the user ID and a password with the user information, which is provided in advance.

5. The lending management system according to claim 2, wherein said user certification unit is provided with an IC card reader for reading the IC card, in which the user ID is registered, and carries out the user certification by checking the user ID and a password with the user information, which is provided in advance.

6. The lending management system according to claim 2, wherein said user certification unit includes a fingerprint input unit for inputting fingerprint of the user, wherein said user certification unit carries out the user certification by checking the fingerprint with the user information, which is provided in advance.

7. The lending management system according to claim 1, wherein said small sized information device is provided with a lock switching unit for switching operation possible/operation impossible in accordance with an input signal,
wherein said server terminal transmits a lock release signal to the small sized information device, which is already registered on carrying out lending.

8. The lending management system according to claim 1, wherein said client terminal is provided with a image transmission method designating unit for designating a method for transmitting an input image data from said small sized information device having image inputting means, and
said server terminal transmits said inputted image data in accordance with an image transmission method, which is designated by the image transmission method designating unit, on returning said small sized information device.

9. The lending management system according to claim 8, wherein the image transmission method, which is designated by the image transmission method designating unit, comprises an electronic computer originated mail.

10. The lending management system according to claim 8, wherein the image transmission method, which is designated by the image transmission method designating unit, employs a FTP (file transfer protocol) in a TCP/IP.

11. The lending management system according to claim 8, wherein the image transmission method, which is designated by the image transmission method designating unit, comprises a PUT command (file transfer) in a HTTP.

12. The lending management system according to claim 8, further comprising a printing unit for printing the input image data on the network,
wherein said small sized information device lending management system transmits the input image data to said printing unit so that said input image data is printed.

13. A small sized information device lending management system comprising:
a client terminal connected to a network; and
a server terminal to which a small sized information device can be connected using a cable or radio waves and is constructed by a WWW server connected to said network;
wherein said client terminal specifies said WWW server by a URL to be inputted by the user and transmits information related to reservation for lending said small sized information device, which information is inputted by a user, to said WWW server via said network;
said server terminal receives the information related to reservation from said client terminal, judges whether reservation for lending said small sized information device can be registered or not in accordance with the received information, and if it is judged that the reservation can be registered, registers the reservation and transmits an information to said client terminal which indicates that the reservation has been registered.

14. The lending management system according to claim 13, wherein said server terminal comprises a user certification unit which authenticates a user in accordance with input information of the user and a lending permission unit which checks the user input information, which is provided with an access right by said user certification unit, and said reservation registration information; in the case that they correspond with each other, permitting to lend said small sized information device.

15. The lending management system according to claim 14, wherein said user certification unit carries out the user certification by checking a user ID to be inputted and a password with the user information, which is provided in advance.

16. The lending management system according to claim 14, wherein said user certification unit is provided with a magnetic card reader for reading the magnetic card, in which the user ID is registered, and carries out the user certification by checking the user ID and a password with the user information, which is provided in advance.

17. The lending management system according to claim 14, wherein said user certification unit is provided with an IC card reader for reading the IC card, in which the user ID is registered, and carries out the user certification by checking the user ID and a password with the user information, which is provided in advance.

18. The lending management system according to claim 14, wherein said user certification unit includes a fingerprint input unit for inputting fingerprint of the user, wherein said user certification unit carries out the user certification by checking the fingerprint with the user information, which is provided in advance.

19. The lending management system according to claim 13, wherein said small sized information device is provided with a lock switching unit for switching operation possible/operation impossible in accordance with an input signal,
wherein said server terminal transmits a lock release signal to the small sized information device, which is already registered on carrying out lending.

20. The lending management system according to claim 13, wherein said client terminal is provided with a image transmission method designating unit for designating a method for transmitting an input image data from said small sized information device having image inputting means, and
said server terminal transmits said inputted image data in accordance with an image transmission method, which is designated by the image transmission method designating unit, on returning said small sized information device.

21. The lending management system according to claim 20, wherein the image transmission method, which is designated by the image transmission method designating unit, comprises an electronic computer originated mail.

22. The lending management system according to claim 20, wherein the image transmission method, which is designated by the image transmission method designating unit, employs a FTP (file transfer protocol) in a TCP/IP.

23. The lending management system according to claim 20, wherein the image transmission method, which is designated by the image transmission method designating unit, comprises a PUT command (file transfer) in a HTTP.

24. The lending management system according to claim 20, further comprising a printing unit for printing the input image data on the network,
wherein said small sized information device lending management system transmits the input image data to said printing unit so that said input image data is printed.

25. The lending management system according to claim 13, wherein said small sized information device lending management system does not transmit the input image data to said client terminal but stores it in said WWW server.

26. A small sized information device comprising a lock switching unit for switching operation possible/operation impossible in accordance with an input signal from the outside.

27. The small sized information device according to claim 26, comprising a displaying unit for displaying rest of a reserved time,
wherein said small sized information device transmits a lock signal again to said lock switching unit when the reserved time is over.

28. A lending reservation method for reserving lending of a small sized information device having a lock function from a terminal via a network comprising:
a user certification step for authenticating a user with an inputted user ID and a password;
a reservation registration/reservation impossible step for confirming that the reservation is competitive or not with respect to a used date of said small sized information device, which the user, who is authenticated by said user certification step, desires, registering said reservation when there is not competition in reservation and transmitting error information to a terminal on the user side when the registration competition occurs;
a reservation registration confirmation step for confirming the user who registers the reservation in said reservation registration/reservation impossible step and said user's reservation information; and
a lock release step for releasing the lock of said small sized information device, which the user, who is confirmed by said reservation registration confirmation step, desires.

29. The lending reservation method according to claim 28, further comprising:
an image transmission method designating step for designating a method for transmitting the image from said small sized information device; and
an image transmission step for transmitting the image in accordance with the image transmission method, which is designated by the image transmission method designating step.

30. The lending reservation method according to claim 29, wherein the image transmission method comprises any one of the electronic computer originated mail, the FTP (file transfer protocol) in the TCP/IP, the PUT command (file transfer) of the HTTP, a printer output and a method for storing the image in the WWW server.

31. A computer readable recording medium for recording a computer program containing instructions which when executed realizes a lending reservation method for reserving lending of a small sized information device having a lock function from a terminal via a network, the lending reservation method comprising:
a user certification step for authenticating a user with an inputted user ID and a password;
a reservation registration/reservation impossible step for confirming that the reservation is competitive or not with respect to a used date of said small sized information device, which the user, who is authenticated by said user certification step, desires, registering said reservation when there is not competition in reservation and transmitting error information to a terminal on the user side when the registration competition occurs;
a reservation registration confirmation step for confirming the user who registers the reservation in said reservation registration/reservation impossible step and said user's reservation information; and
a lock release step for releasing the lock of said small sized information device, which the user, who is confirmed by said reservation registration confirmation step, desires.
